(19) United States
(12) Patent Application Publication
(10) Pub. No.: US 2023/0400139 A1
(43) Pub. Date: Dec. 14, 2023

(54) SLEEVE CLAMP ASSEMBLY WITH IMPROVED CHAIN HAVING AN INTEGRAL JACK CAP

(71) Applicant: LaValley Industries, LLC, Bemidji, MN (US)

(72) Inventors: Jason LAVALLEY, Bemidji, MN (US); Douglas COUTLEE, Bemidji, MN (US); Don PEET, Bemidji, MN (US)

(21) Appl. No.: 18/249,347

(22) PCT Filed: Oct. 20, 2021
(86) PCT No.: PCT/IB2021/059688

§ 371 Date: Apr. 17, 2023

Related U.S. Application Data
(60) Provisional application No. 63/094,557, filed on Oct. 21, 2020.

(51) Int. Cl. F16L 55/18; F16L 3/14; F16G 13/16

(52) U.S. Cl. CPC F16L 55/18; F16L 3/14; F16G 13/16

(57) ABSTRACT

A sleeve clamp assembly that can be used in a repair process on a steel pipe or steel pipeline. The sleeve clamp assembly includes a chain assembly that is constructed with a number of features that are not found on conventional chains used on conventional sleeve clamp assemblies used for pipe repair, such as a chain identifier fixed to the chain assembly that uniquely identifies the chain assembly, a heat indicator that indicates overheating of a chain of the chain assembly, and/or a tension indicator link that indicates tension applied to the chain. The sleeve clamp assembly is an engineered design that is certified to meet predefined specifications, is designed to measure and document wear on the chain, and is provided with integral instructions for proper use of the sleeve clamp assembly.

### FIELD

This technical disclosure relates to repairing steel pipeline using steel pipe repair sleeves.

### BACKGROUND

It is known to repair steel pipeline using a steel pipe repair sleeve. The steel pipe repair sleeve can be used to fix a weakness in a section of steel pipe, cover a hole in the pipe, bridge a gap between the ends of two sections of pipe, and the like. The pipe repair sleeve can comprise two sections that encircle or substantially encircle the entire circumference of the pipe, or the sleeve can be configured to cover only a portion of the circumference of the pipe.

During the repair, the repair sleeve is clamped to the pipe so that the repair sleeve conforms to the pipe circumference. Various clamping tools are known in the art. Once the repair sleeve is clamped in position, the repair sleeve is then welded to the pipe.

### SUMMARY

A sleeve clamp assembly that can be used in a repair process on a steel pipe or steel pipeline is described. The sleeve clamp assembly is constructed with a number of features that are not found on conventional clamping tools used for pipe repair. The described sleeve clamp assembly provides significant technological and safety advancements in sleeve clamp assemblies used for pipe repair.

The sleeve clamp assembly includes a chain assembly that has a steel chain with a number of technological and/or safety features not found on conventional chains used in conventional sleeve clamp assemblies. The features can be used individually or in any combination. For example, the chain can include a tension indicator link that indicates excessive tension applied to the chain (i.e. the chain has been over tensioned). In one embodiment, the tension indicator link can permanently deform as a result of excessive tension. The chain can include a chain identifier fixed to the chain that uniquely identifies the chain. The chain identifier ties all of the components of the chain assembly to one integrated assembly and helps to prevent parts of the chain being replaced, added to or removed from the chain assembly. The chain can include a heat indicator that indicates overheating of the chain that can result from pre-heating or welding that takes place during the pipe repair process. Overheating of the chain can weaken the chain and make the chain unsafe for further use in the sleeve clamp assembly. The chain can include a gauge tag that is fixed to the chain. In some embodiments, the chain identifier can be located on the gauge tag. The gauge tag can be configured to assist in measuring mechanical properties of the chain such as, but not limited to, a maximum length of links of the chain, a maximum chain pitch, a link diameter, and interface with the tension indicator link to gauge tension.

In some embodiments, one or more radio frequency identification (RFID) tags can be provided on the chain assembly. For example, the RFID tag can be located on the tension indicator link, the chain grab hook, or on a jack cap that can be integrally associated with the chain. The RFID tag(s) can store data relating to the chain assembly, including the chain identifier, permitting a check to be performed to confirm that the chain identifier on the gauge tag matches the chain identifier stored on the RFID tag thereby confirming that the correct chain assembly is being used. The chain identifier on the RFID tag can also be read from the RFID tag and used to access a spreadsheet or other report that includes data regarding the chain assembly and the history of the chain assembly including, but not limited to, the date of manufacture of the chain assembly, date(s) of service or repair performed on the chain assembly, who did the service/repair, and the like.

The sleeve clamp assembly further includes a jack that is used to tighten the chain around the pipe during clamping of the repair sleeve. In some embodiments, the chain assembly can include an integral jack cap that in use interfaces with the jack to detachably connect the jack to the chain assembly. The jack can be a journal jack, a hydraulic jack, or any other type of jack that can tighten the chain around the pipe during clamping.

Conventional sleeve clamp assemblies are not engineered designs and typically use components, such as chains, that are not designed for a sleeve clamp application. In addition, components used in conventional sleeve clamps assemblies are not certified to meet any specification, wear on the components is not measured or documented, and instructions for proper use of conventional sleeve clamps assemblies are typically undocumented.

In one embodiment described herein, a sleeve clamp assembly can include a jack cap, and a steel chain having a plurality of interconnected steel links, where the steel chain has a length that is sufficient to extend around a circumference of a steel pipe. The steel chain has a first end fixed to the jack cap, a second end fixed to the jack cap, and an intermediate section between the first end and the second end. In addition, the steel chain includes at least one of the following: a chain identifier fixed to the steel chain that uniquely identifies the steel chain; a heat indicator that indicates overheating of the steel chain; and a tension indicator link secured to the intermediate section, where the tension indicator link indicates tension, for example excessive tension, applied to the steel chain.

In another embodiment described herein, a method of pipe repair can include arranging a pipe repair sleeve on one or more pipes in need of repair. The pipe repair sleeve is then secured to the one or more pipes using a sleeve clamp assembly that includes a chain assembly that has a steel chain having a plurality of interconnected steel links, where the chain assembly includes at least one of the following: a chain identifier fixed to the chain assembly that uniquely identifies the chain assembly; a heat indicator that indicates overheating of the steel chain; and a tension indicator link that indicates tension, for example excessive tension, applied to the steel chain.

### DRAWINGS

FIG. 1 is a perspective view of the sleeve clamp assembly described herein clamping a steel pipe repair sleeve to a steel pipe.

FIG. 2 is an end view of FIG. 1.

FIG. 3 illustrates the chain assembly of the sleeve clamp assembly.

FIG. 4 is a close-up perspective view of the jack cap of the chain assembly.

FIG. 5 is a close-up view of the tension indicator link of the chain assembly.

FIG. 6 illustrates an example of one side of a gauge tag of the chain assembly.

FIG. 7 illustrates one example of use of the gauge tag.

FIG. 8 illustrates another example of use of the gauge tag.

FIG. 9 illustrates another example of use of the gauge tag.

FIG. 10 illustrates a portion of another type of chain that can be used in the chain assembly described herein.

### DETAILED DESCRIPTION

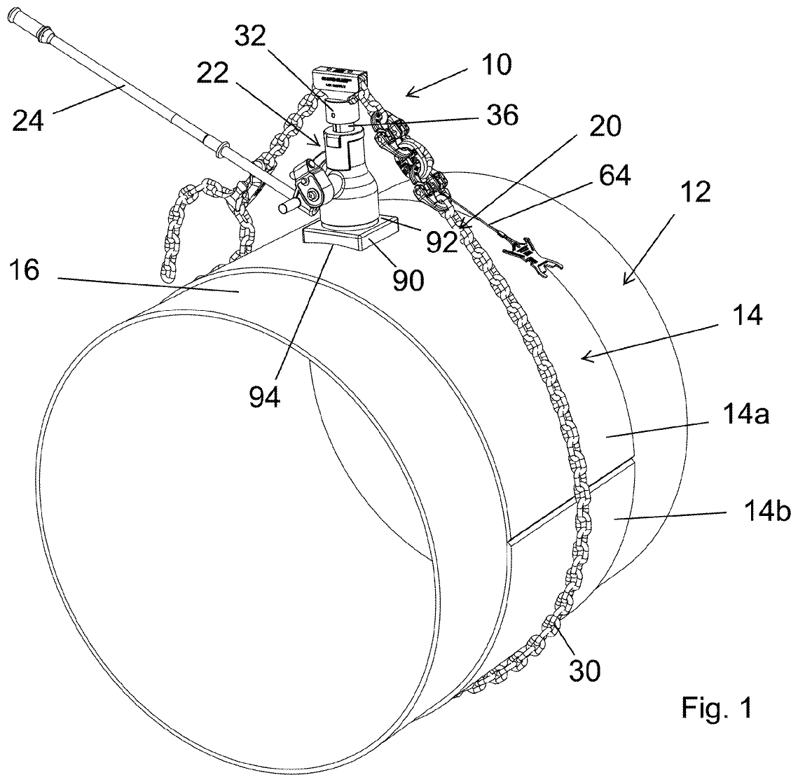

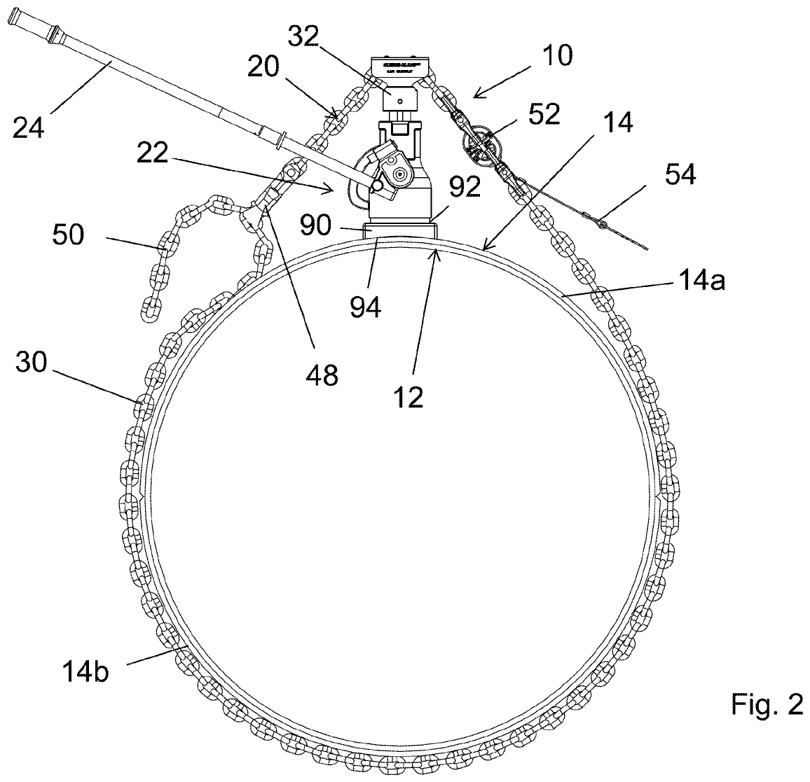

With reference to FIGS. 1 and 2, an example of a sleeve clamp assembly 10 described herein is illustrated. The sleeve clamp assembly 10 is used in a repair process on a pipe 12 which can be formed of steel or other materials. In particular, the sleeve clamp assembly 10 is used to clamp a pipe repair sleeve 14, which can be formed of the same material as the pipe 12 including steel, to the outer circumferential surface 16 of the pipe 12 so that the sleeve 14 conforms to the surface 16. The sleeve 14 can be used to fix a weakness in a section of the pipe 12, cover a hole in the pipe 12, bridge a gap between the ends of two sections of the pipe 12, and the like. The sleeve 14 can comprise two sections 14a, 14b as illustrated that encircle or substantially encircle the entire circumference of the pipe 12, or the sleeve 14 can comprise only one section and be configured to cover only a portion of the circumference of the pipe 12. Once the sleeve 14 is clamped in position on the pipe 12, the sleeve 14 can be permanently secured to the surface 16, for example by welding the sleeve 14 to the pipe 12 along the edges of the sleeve 14 which adjoin the surface 16. Pipe repair using a sleeve that is clamped to the pipe is well known in the art and further description of details of the repair process are not required.

With continued reference to FIGS. 1 and 2, the sleeve clamp assembly 10 is shown as including a chain assembly 20 and a jack 22. The chain assembly 20 is configured to engage the sleeve 14 and clamp the sleeve 14 to the pipe 12. The chain assembly 20 applies a force to the sleeve 14 to deform the sleeve 14 so that the sleeve 14 more closely conforms to the surface 16. The jack 22 is configured to apply a force to the chain assembly 20 and thereby tension the chain assembly 20.

The jack 22 can have any construction that is suitable for applying a force to the chain assembly 20 to tension chain assembly 20 around the sleeve 14 and the pipe 12. For example, the jack 22 is illustrated in FIGS. 1-2 as being a journal jack. The construction and operation of journal jacks is well known in the art. An example of a suitable journal jack that can be used is the Simplex brand available from Enerpac Tool Group. However, the jack 22 can be a hydraulic jack or any other type of jack.

As best seen in FIGS. 1 and 2, the jack 22 is preferably constructed so that the jack 22 can be actuated by a torque wrench 24 that acts as the ratchet handle for the jack 22. The torque wrench 24 can be preset to a particular torque setting, corresponding to a maximum tension on the chain assembly, to limit the extent of actuation of the jack 22 and thereby limit the resulting tension on the chain assembly 20. Depending upon the jack that is used, the preset torque setting of the torque wrench may need to be adjusted or changed to result in the desired engineered tension value/limit on the chain assembly being obtained.

Referring to FIGS. 1-3, the chain assembly 20 includes a chain 30 that can be made of, for example, steel. The chain 30 has a length that is sufficient to allow the chain 30 to extend around a circumference of the pipe 12. The pipe 12 can have a diameter of, for example, 12 inches, 20 inches, 30 inches, 42 inches and 48 inches. Therefore, the chain 30 needs to have a length sufficient to encircle these size of pipes. However, the pipe 12 can have other diameters, including smaller than 12 inches and greater than 42 inches.

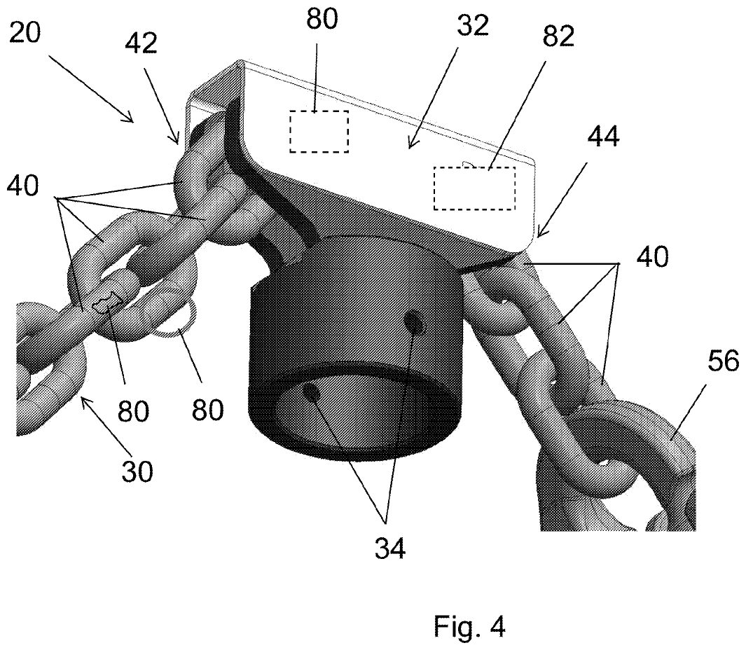

Referring to FIGS. 1 and 4, the chain assembly 20 can further include a jack cap 32. The jack cap 32 is integral with the chain 30 and is used to attach the chain 30 to the jack 22. For example, the jack cap 32 can include a pair of pin holes 34 extending therethrough that receive a pin (not visible) that detachably secures an actuator shaft 36 of the jack 22 to the jack cap 32.

Referring to FIGS. 1-4, the chain 30 includes a plurality of interconnected steel links 40. As best seen in FIG. 4, the link 40 at one end 42 of the chain 30 is fixed to the jack cap 32 and the link 40 at the other end 44 of the chain 30 is fixed to the jack cap 32. An intermediate section 46 of the chain 30 between the ends 42, 44 includes a plurality of the links 40 and other features described below.

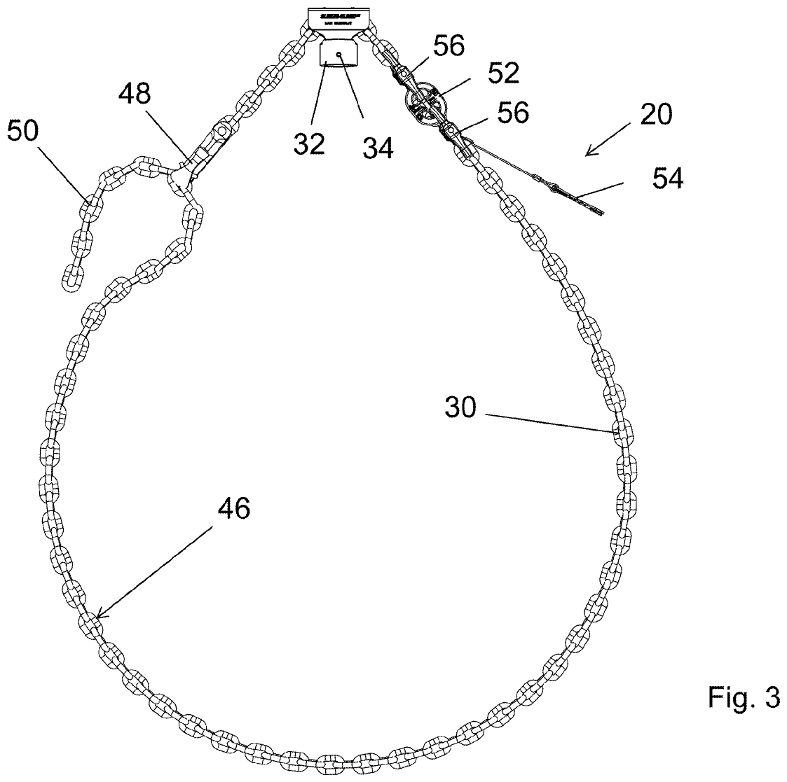

Referring to FIGS. 2 and 3, the intermediate section 46 of the chain 30 includes a chain grab hook 48 that detachably connects to the links 40 at a free section 50 of the chain 30 to permit adjustment in the size (i.e. the diameter and the length between the ends 42, 44) of the chain 30. In addition, the intermediate section 46 of the chain 30 includes a tension indicator link 52, a gauge tag 54, and a heat indicator (not visible).

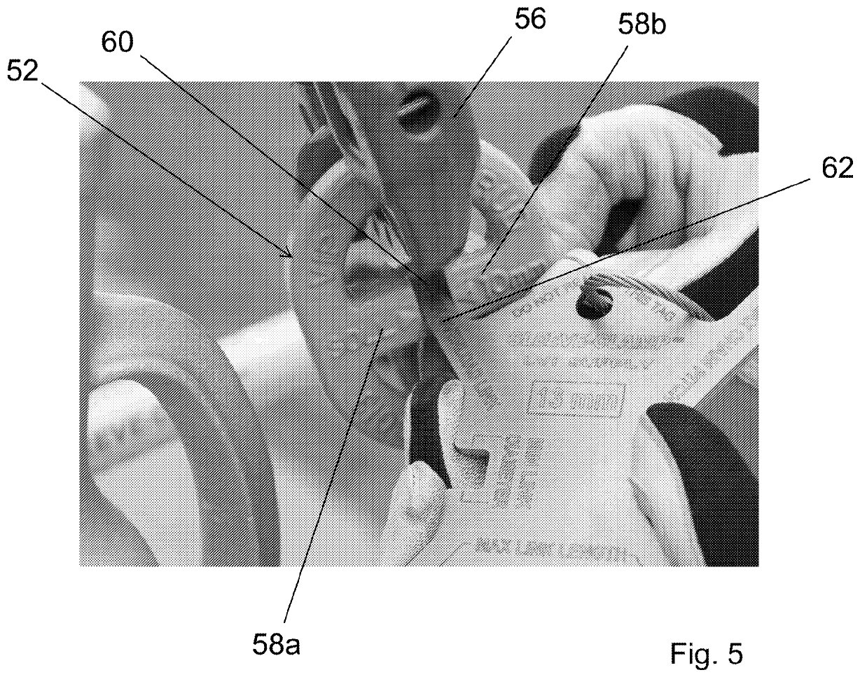

Referring to FIGS. 3-5, the tension indicator link 52 comprises a connecting link 56 at each end thereof that connect to the links 40 to secure the tension indicator link 52 to the chain 30. As best seen in FIG. 5, the tension indicator link 52 comprises an oval shaped member with indicator elements 58a, 58b at the center thereof that extend toward one another and define a gap therebetween. The size of the gap 60 indicates the tension applied to the chain 30. Tension on the chain 30 causes the link 52 to permanently stretch thereby causing the gap 60 to decrease. As long as the gap 60 maintains a minimum size, the chain 30 is not considered overtensioned. If the chain 30 is overtensioned, the gap 60 decreases below a minimum size, and measuring the gap 60 can therefore detect whether the chain 30 has been overtensioned. The size of the gap 60 can be detected by a gap measuring element 62 on the gauge tag 54 described further below. An example of a tension indicator link that can be used is the VIP Overload Control link available from The RUD Group (RUD Ketten Rieger & Dietz GmbH u. Co. KG) of Aalen, Germany.

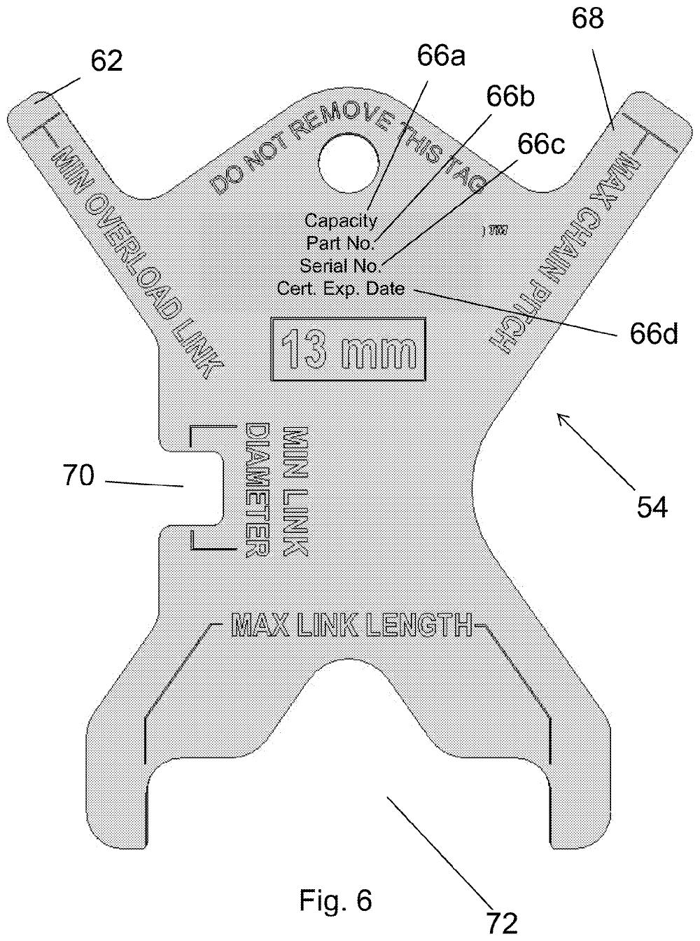

Referring to FIGS. 1-3 and 6, the gauge tag 54. The gauge tag 54 is tethered to the chain via a suitable tether 64 (best seen in FIG. 1), such as a wire, to permanently attach the gauge tag 54 to the chain 30. The gauge tag 54 is a flat, plate-like structure that provides a surface for locating data regarding the chain 30, such as a maximum rated capacity 66a of the chain 30, a part number 66b for the chain 30, a chain identifier such as a serial number 66c of the chain 30 that uniquely identifies the specific chain 30, and a certification expiration date 66d which indicates a date that the rated performance characteristics of the chain 30 are guaranteed to assuming the performance specifications have not been exceeded.

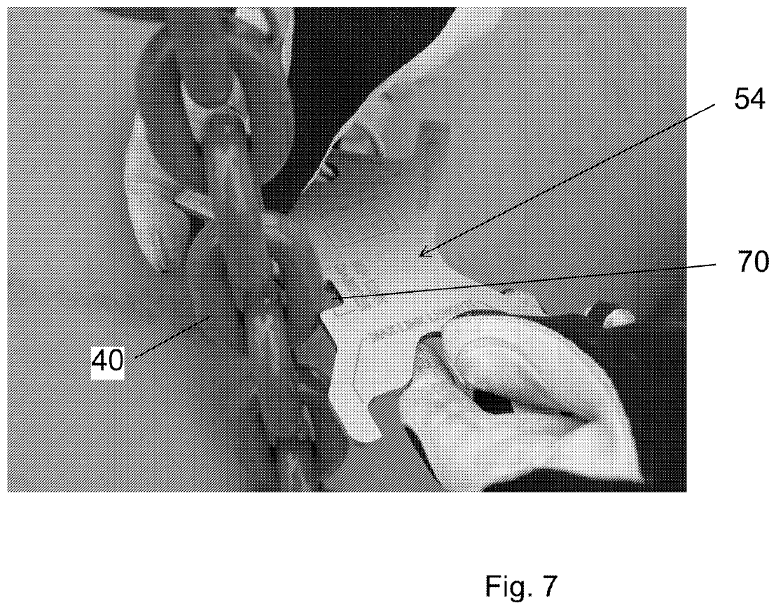

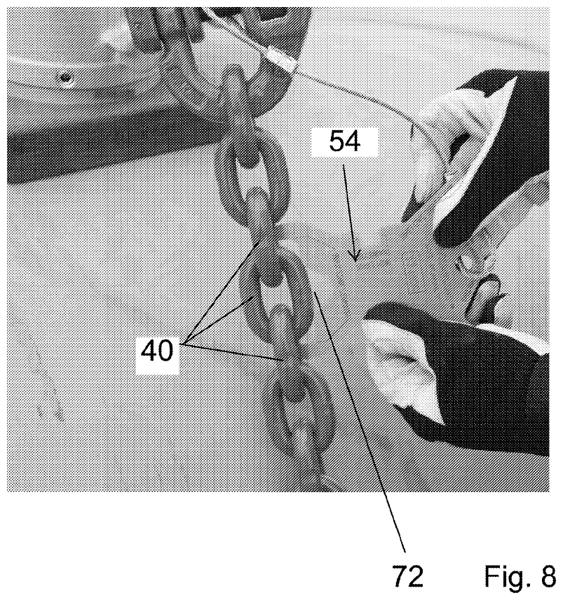

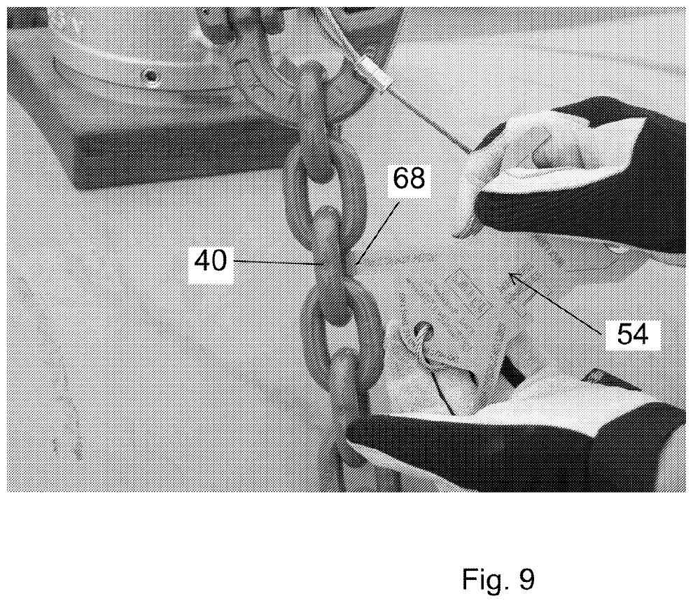

The gauge tag 54 is also configured to assist in manually measuring mechanical properties of the chain 30. For example, the tag 54 includes the gap measuring element 62 for measuring the gap 60 in the tension indicator link 52 as depicted in FIG. 5, a pitch measuring element 68 for manually measuring a maximum chain pitch as depicted in FIG. 9, a link diameter measuring element 70 for measuring a diameter of the links 40 as depicted in FIG. 7, and a link length measuring element 72 that measures a maximum length of the links 40 as depicted in FIG. 8. An example of a gauge tag 54 that can be used and that has elements for measuring mechanical properties of a chain is the ICE Identification Tag available from The RUD Group (RUD Ketten Rieger & Dietz GmbH u. Co. KG) of Aalen, Germany.

The chain 30 further includes a heat indicator that indicates overheating of the chain 30. The heat indicator can be any mechanism associated with the chain 30 for indicating a level of heat applied to the chain 30. In one embodiment, the heat indicator can comprise a coating on some or all of the chain 30 where the coating permanently changes color when the chain 30 is overheated. An example of a heat indicator coating on a chain that permanently changes color when overheated is the ICE powder coated chain available from The RUD Group (RUD Ketten Rieger & Dietz GmbH u. Co. KG) of Aalen, Germany. In other embodiments, a mechanical heat indicator, such as a heat sensor, can be mounted on the chain 30 to measure the heat applied to the chain 30.

In another embodiment, the chain 30 can include at least one RFID tag mounted thereon. For example, with reference to FIG. 4, a ring-shaped RFID tag 80 can be mounted around one of the links 40. In another embodiment, the RFID tag 80 can be embedded in or otherwise incorporated into one of the links 40. In still another embodiment, the RFID tag 80 can be located on the jack cap 32. Regardless of where the RFID tag 80 is located, the RFID tag 80 can store data relating to the chain 30, including the chain identifier 66c and optionally the other data 66a, 66b, 66d, permitting a check to be performed to confirm that the data such as the chain identifier 66c on the gauge tag 54 matches the chain identifier stored on the RFID tag 80 thereby confirming that the correct chain 30 is being used. In addition, the chain identifier 66c or other data can be read from the RFID tag 80 and used to access a spreadsheet or other report that includes data regarding the chain assembly 20 and the history of the chain assembly 20 including, but not limited to, the date of manufacture of the chain assembly 20, date(s) of service or repair performed on the chain assembly, who did the service/repair, and the like. An example of a ring-shaped RFID tag on a link of a chain is the RUD-ID-TAG® available from The RUD Group (RUD Ketten Rieger & Dietz GmbH u. Co. KG) of Aalen, Germany. Regardless of the type of RFID tag that is used, the RFID tag 80 can be read and written to using conventional RFID read/write equipment.

With continued reference to FIG. 4, an optional strain gauge 82 can be connected to the jack cap 32. The strain gauge 82 can be used to measure the strain on the jack cap 32 during use. In some embodiments, strain data from the strain gauge 82 can be transmitted in real time during use to a receiving device such as a tablet, mobile phone or laptop computer. This permits the strain to be continuously monitored in real-time during use, and a warning can be triggered to alert the user in the event that the measured strains on the jack cap 32 exceed a threshold level. Power for the strain gauge 82 can be provided by a power source mounted on the jack cap 32 or elsewhere on the chain assembly 20. A data transmitter can also be mounted on the jack cap 32 or elsewhere on the chain assembly 20 and connected to the strain gauge 82 and the power source to measure the strains and transmit the measured strains to a receiving device.

Referring back to FIGS. 1 and 2, a base cradle 90 is disposed between a base of the jack 22 and the sleeve 14 (or the outer surface 16) to support the jack 22. The base cradle 90 has a first, flat surface 92 that in use is engaged with the base of the jack 22, and a second, curved surface 94 opposite the surface 92 that interfaces with the sleeve 14 or the surface 16. The curvature of the surface 94 generally matches the curvature of the sleeve 14 or the surface 16. Therefore, a plurality of the base cradles 90 can be provided, each configured for use with a different sized (i.e. diameter) pipe, where the curvatures of the surfaces 94 of the base cradles 90 are different from one another.

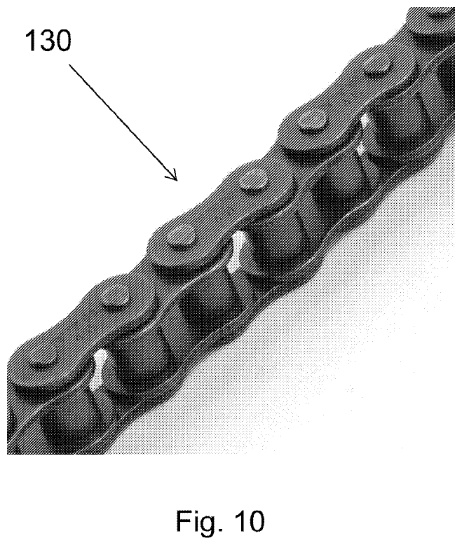

FIG. 10 illustrates another example of a type of chain 130 that can be used instead of the chain 30. The chain 130 would include the same features as the chain 30 including having the jack cap, the tension indicator link, the heat indicator, the gauge tag with the chain identifier, the RFID tag(s), the chain grab hook, etc.

In use of the sleeve clamp assembly 10 for repairing a pipe, the pipe repair sleeve 14 is disposed on the pipe 12 in need of repair (see FIGS. 1 and 2). Thereafter, the sleeve clamp assembly 10 is disposed around the sleeve 14 as depicted in FIGS. 1 and 2, with the chain 30, 130 encircling the pipe 12 and the sleeve 14, and the jack 22 disposed on the base cradle 90 and secured to the chain 30, 130 by securing the actuator shaft 36 to the jack cap 22. The torque wrench 24 is then used as a ratchet handle to actuate the jack 22 which pushes the actuator shaft 36 and the jack cap 22 upward in FIGS. 1 and 2. This tensions the chain 30, 130 around the pipe 12, deforming the sleeve 14 to conform the sleeve 14 to the surface 16. The torque wrench 24 is actuated up to its preset torque limit, at which point the chain 30, 130 is at its engineered tension limit. Once the sleeve 14 is properly clamped around the pipe 12, the sleeve 14 is then welded to the pipe 12 along the edges of the sleeve 14 which adjoin the surface 16.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A sleeve clamp assembly, comprising:
a jack cap;
a steel chain having a plurality of interconnected steel links, the steel chain having a length that is sufficient to extend around a circumference of a steel pipe;
the steel chain having a first end fixed to the jack cap, a second end fixed to the jack cap, and an intermediate section between the first end and the second end;
the steel chain includes at least one of the following:
a) a chain identifier fixed to the steel chain that uniquely identifies the steel chain;
b) a heat indicator that indicates overheating of the steel chain;
c) a tension indicator link secured to the intermediate section, the tension indicator link indicates tension applied to the steel chain;
d) at least one radio frequency identification tag.

2. The sleeve clamp assembly of claim 1, wherein the steel chain includes a), b), c) and d).

3. The sleeve clamp assembly of claim 1, wherein the chain identifier comprises a serial number that is on a gauge tag that is fixed to the steel chain.

4. The sleeve clamp assembly of claim 1, wherein the heat indicator comprises a coating on the steel chain that permanently changes color when the steel chain is overheated.

5. The sleeve clamp assembly of claim 1, wherein the tension indicator link is disposed between two of the steel links.

6. The sleeve clamp assembly of claim 1, further comprising a strain gauge connected to the jack cap.

7. The sleeve clamp assembly of claim 1, further comprising a jack that is securable to the jack cap.

8. The sleeve clamp assembly of claim 7, wherein the jack comprises a journal jack.

9. The sleeve clamp assembly of claim 8, further comprising a torque wrench that actuates the journal jack.

10. The sleeve clamp assembly of claim 7, further comprising a plurality of base cradles; each base cradle having a first, flat surface that in use supports a base of the jack, and a second, curved surface opposite the first, flat surface; and the second, curved surfaces have different curvatures.

11. A method of pipe repair, comprising:
arranging a pipe repair sleeve on one or more pipes in need of repair;
securing the pipe repair sleeve to the one or more pipes using a sleeve clamp assembly that includes a chain assembly having a steel chain with a plurality of interconnected steel links; the chain assembly includes at least one of the following: a) a chain identifier fixed to the chain assembly that uniquely identifies the chain assembly; b) a heat indicator that indicates overheating of the steel chain; c) a tension indicator link that indicates tension applied to the steel chain; and d) a radio frequency identification tag.

12. The method of pipe repair of claim 11, wherein the chain assembly includes a), b), c) and d).

13. The method of pipe repair of claim 11, wherein the chain identifier comprises a serial number that is on a gauge tag that is fixed to the steel chain; the heat indicator comprises a coating on the steel chain that permanently changes color when the steel chain is overheated; and the tension indicator link is disposed between two of the steel links.

14. The method of pipe repair of claim 11, wherein the chain assembly further comprises a jack cap, a first end of the steel chain is fixed to the jack cap, a second end of the steel chain is fixed to the jack cap, and further comprising measuring strain on the jack cap using a strain gauge connected to the jack cap.

15. The method of pipe repair of claim 14, further comprising securing the pipe repair sleeve to the one or more pipes using a jack that is detachably secured to the jack cap.

16. The method of pipe repair of claim 15, wherein the jack comprises a journal jack.

17. The method of pipe repair of claim 16, further comprising using a torque wrench to actuate the journal jack.

18. The method of pipe repair of claim 15, further comprising arranging a base cradle between the jack and the sleeve or a surface of the one or more pipes; the base cradle having a first, flat surface that is engaged with a base of the jack, and a second, curved surface that is opposite the first, flat surface.
